(19) United States
(12) Patent Application Publication
(10) Pub. No.: US 2024/0219509 A1
(43) Pub. Date: Jul. 4, 2024

(54) INFORMATION PROCESSING SYSTEM, INFORMATION PROCESSING APPARATUS, INFORMATION PROCESSING METHOD, AND INFORMATION PROCESSING PROGRAM

(71) Applicant: Sony Group Corporation, Tokyo (JP)

(72) Inventor: Atsushi IZUMIHARA, Tokyo (JP)

(73) Assignee: Sony Group Corporation, Tokyo (JP)

(21) Appl. No.: 18/558,538

(22) PCT Filed: Mar. 15, 2022
(86) PCT No.: PCT/JP2022/011533

§ 371 Date: Nov. 2, 2023

(30) Foreign Application Priority Data
May 11, 2021 (JP) 2021-080296

(51) Int. Cl. G01S 5/02; G05D 1/229; G05D 1/246; G05D 1/646; G05D 111/30

(52) U.S. Cl. CPC G01S 5/02524; G05D 1/2297; G05D 1/246; G05D 1/646; G05D 2111/32

(57) ABSTRACT

An information processing system according to an embodiment includes: an acquisition unit that acquires a radio wave condition in an environment, and a creation unit that creates an operation plan on the basis of the radio wave condition and radio field intensity necessary for transmitting video data to be used for distribution.

### FIELD

The present disclosure relates to an information processing system, an information processing apparatus, an information processing method, and an information processing program.

### BACKGROUND

Live distribution is known in which a performance such as live music is captured, and the captured video data and audio data are distributed in real-time. In the live distribution, cost saving and content expansion are required. In such a circumstance, it has been proposed to use an autonomously moving robot for capturing a video in the live distribution.

In a case where a moving robot is used for capturing and distribution a video, the captured video data and audio data are desirably transmitted from the robot by wireless communication. This is because it is desired to move vertically and horizontally for capturing a video on the stage on which the performance is performed, and to minimize the influence on the performers and equipment on the stage. Patent Literature 1 discloses a moving robot with a wireless communication unit, the moving robot capable of being remotely operated.

### CITATION LIST

### Patent Literature

Patent Literature 1: JP 2004-260769 A

### SUMMARY

### Technical Problem

However, when the video data is transmitted by wireless communication, depending on a radio wave condition, there is a possibility that the quality of the video based on the transmitted video data is deteriorated or the video based on the video data is interrupted. Such deterioration in the quality of the video, interruption of the distribution video, and the like become extremely serious problems in the live distribution.

An object of the present disclosure is to provide an information processing system, an information processing apparatus, an information processing method, and an information processing program capable of stably providing a video based on video data transmitted from a mobile device that autonomously moves.

### Solution to Problem

For solving the problem described above, an information processing system according to one aspect of the present disclosure has an acquisition unit that acquires a radio wave condition in an environment; and a creation unit that creates an operation plan on the basis of the radio wave condition and radio field intensity necessary for transmitting video data to be used for distribution.

### BRIEF DESCRIPTION OF DRAWINGS

FIG. 1 is a schematic diagram for explaining a video distribution system related to the present disclosure.

FIG. 2 is a schematic diagram illustrating a configuration of an example of an information processing system as a video distribution system according to an embodiment.

FIG. 3 is a functional block diagram of an example for explaining functions of an information processing apparatus according to an embodiment.

FIG. 4 is a block diagram illustrating an example of a hardware configuration of the information processing apparatus according to an embodiment.

FIG. 5 is a functional block diagram of an example for explaining functions of a video selection device applicable to an embodiment.

FIG. 6 is a schematic diagram illustrating an example of a video selection screen to be displayed on a display by a display unit of the video selection device, which can be applied to an embodiment.

FIG. 7A is a schematic diagram illustrating an example of an appearance of a mobile device applicable to an embodiment.

FIG. 7B is a schematic diagram illustrating an example of an appearance of a mobile device applicable to an embodiment.

FIG. 8 is a block diagram illustrating an example of a hardware configuration of a mobile device applicable to an embodiment.

FIG. 9 is a functional block diagram of an example for explaining functions of a mobile device applicable to an embodiment.

FIG. 10 is a schematic diagram illustrating an example of a visualization screen displaying visualization of radio wave conditions and a movement route of a mobile device based on an operation plan according to a first embodiment.

FIG. 11 is a schematic diagram illustrating an example in which the visualization screen according to the first embodiment is applied to a screen representing a three-dimensional space.

FIG. 12 is a schematic diagram illustrating an example of a visualization screen according to a first modification of the first embodiment.

FIG. 13 is a schematic diagram illustrating an example of an operation on a slider on the visualization screen according to the first modification of the first embodiment.

FIG. 14 is a schematic diagram for explaining generation of an electric field intensity map and creation of an operation plan according to the first modification of the first embodiment.

FIG. 15 is a diagram for explaining that the state of radio waves transmitted from the mobile device differs depending on the orientation of the mobile device.

FIG. 16 is a flowchart of an example illustrating creation processing of an operation plan according to a second modification of the first embodiment.

FIG. 17A is a diagram for explaining route division and takeover of operation of a mobile device 10 according to a second embodiment.

FIG. 17B is a diagram for explaining route division and takeover of operation of the mobile device 10 according to the second embodiment.

FIG. 18 is a flowchart illustrating an example of creation processing of an operation plan according to the second embodiment.

FIG. 19 is a schematic diagram illustrating an example of a video selection screen by a video selection device according to a third embodiment.

FIG. 20 is an enlarged schematic diagram illustrating a display area according to the third embodiment.

FIG. 21 is a schematic diagram for explaining processing of obtaining a risk level of interruption of a video in distribution.

FIG. 22 is a flowchart of an example illustrating video switching processing according to a risk level in the video selection device according to the third embodiment.

FIG. 23 is a schematic diagram for explaining processing of obtaining a risk level of interruption of a video in distribution according to a modification of the third embodiment.

FIG. 24 is a schematic diagram illustrating an example in which a position where disturbance of a video is detected is reflected on a radio wave condition map according to a modification of the third embodiment.

### DESCRIPTION OF EMBODIMENTS

Hereinafter, embodiments of the present disclosure will be described in detail with reference to the drawings. In each of the following embodiments, the same parts are denoted by the same reference numerals, and redundant description will be omitted.

Hereinafter, embodiments of the present disclosure will be described in the following order.
1. Video Distribution System Related to Present Disclosure
2. Configuration Applicable to Embodiment of Present Disclosure
3. First Embodiment
3-1. First Modification of First Embodiment
3-2. Second Modification of First Embodiment
4. Second Embodiment
5. Third Embodiment
5-1. Modification of Third Embodiment

### 1. Video Distribution System Related to Present Disclosure

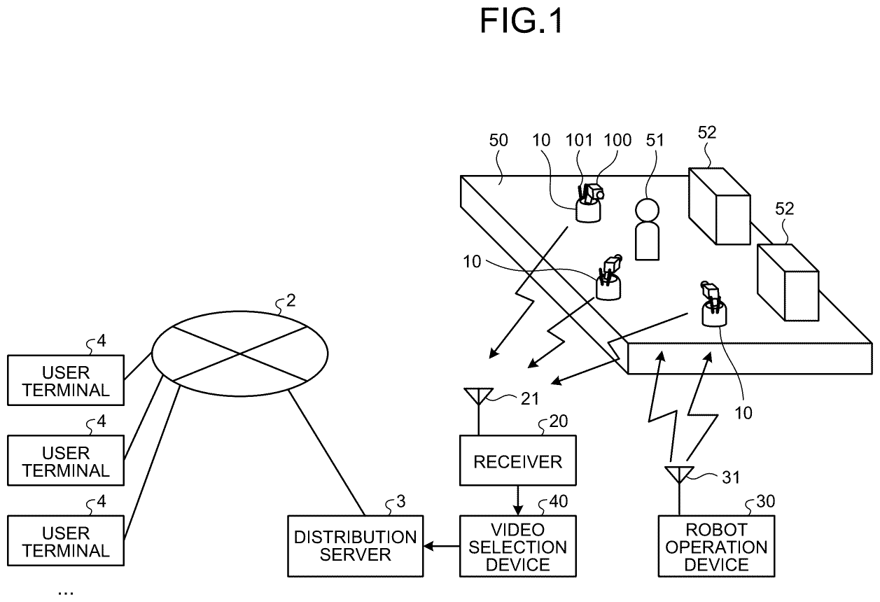

Prior to describing each exemplary embodiment of the present disclosure, a video distribution system related to the present disclosure will be schematically described for easy understanding. FIG. 1 is a schematic diagram for explaining a video distribution system related to the present disclosure. In the example of FIG. 1, the video distribution system includes a plurality of mobile devices 10, a receiver 20 for receiving video data transmitted from each of the mobile devices 10, a video selection device 40 for selecting video data to be used for distribution from each video data received by the receiver 20, and a robot operation device 30 for remotely operating each of the mobile devices 10.

A mobile device 10 is equipped with a camera 100, and includes a transmitter (not illustrated) and an antenna 101 for transmitting video data to the receiver 20. Although not illustrated, the mobile device 10 further includes a receiver and an antenna for receiving a control signal from the robot operation device 30. Furthermore, the mobile device 10 includes a drive mechanism for rotating and moving the housing of the mobile device 10, and can change the orientation of the camera 100 and move according to a control signal from the robot operation device 30.

Each mobile device 10 is disposed, for example, on a stage 50. On the stage 50, for example, a performer 51 who plays a performance, a stage setting or equipment (here, collectively referred to as equipment and the like 52) are arranged. The mobile device 10 moves on the stage 50 according to a control signal transmitted from the robot operation device 30 or a motion programmed in advance, and captures a video with the camera 100. In each mobile device 10, video data captured and obtained by the camera 100 is transmitted by the antenna 101 and received by the receiver 20.

The receiver 20 transfers each video data received from each mobile device 10 to the video selection device 40. Further, the video selection device 40 may transfer video data from a camera other than the camera 100 of the mobile device 10, such as a camera for a person to carry and capture a video, or a camera fixed or movably provided on a predetermined base, by wired or wireless communication. The video selection device 40 is a so-called switcher, displays a video corresponding to each piece of video data on a display, and selects video data to be output from each piece of video data in real-time according to a user operation with respect to the performance of the performer 51, for example. The video data selected by the video selection device 40 is transferred to, for example, a distribution server 3. The distribution server 3 transmits the transferred video data to a network 2, which is, for example, the Internet.

The video data transmitted to the network 2 is received by each user terminal 4 connected to the network 2. Each user who operates each user terminal 4 can view the video data received via the network 2 by displaying the video data on the display of each user terminal 4.

In the existing technology, in such a configuration, depending on a positional relationship between the receiver 20, the mobile device 10, and the performer 51 and the equipment and the like 52 on the stage, a situation may occur in which video data transmitted from the mobile device 10 is difficult to reach the receiver 20. In such a radio wave condition, there is a possibility that the distributed video is interrupted. In the video distribution, it is necessary to prevent the distributed video from being interrupted.

In the embodiment, the video distribution system acquires a radio wave condition indicating a radio wave condition in an environment (for example, on the stage 50) in which the mobile device 10 operates. The video distribution system creates an operation plan for each mobile device 10 to capture a video while autonomously moving on the basis of the acquired radio wave condition and information on radio field intensity necessary and sufficient for transmitting video data. Therefore, in a case of capturing a video while moving by the mobile device 10, it is possible to prevent the video being distributed from being interrupted. Therefore, according to the embodiment, it is possible to stably provide a video based on the video data transmitted from a mobile device that autonomously moves.

Note that the radio field intensity refers to a signal strength of a signal transmitted from the mobile device 10 with a predetermined signal strength at the receiver 20 when the signal is received by the receiver 20. In addition, for example, it is possible to generate a map of radio field intensity on the stage 50 on the basis of each signal strength of signals transmitted from the mobile device 10 at a plurality of positions on the stage 50 and position information indicating the position where the signal is transmitted.

### 2. Configuration Applicable to Embodiment of Present Disclosure

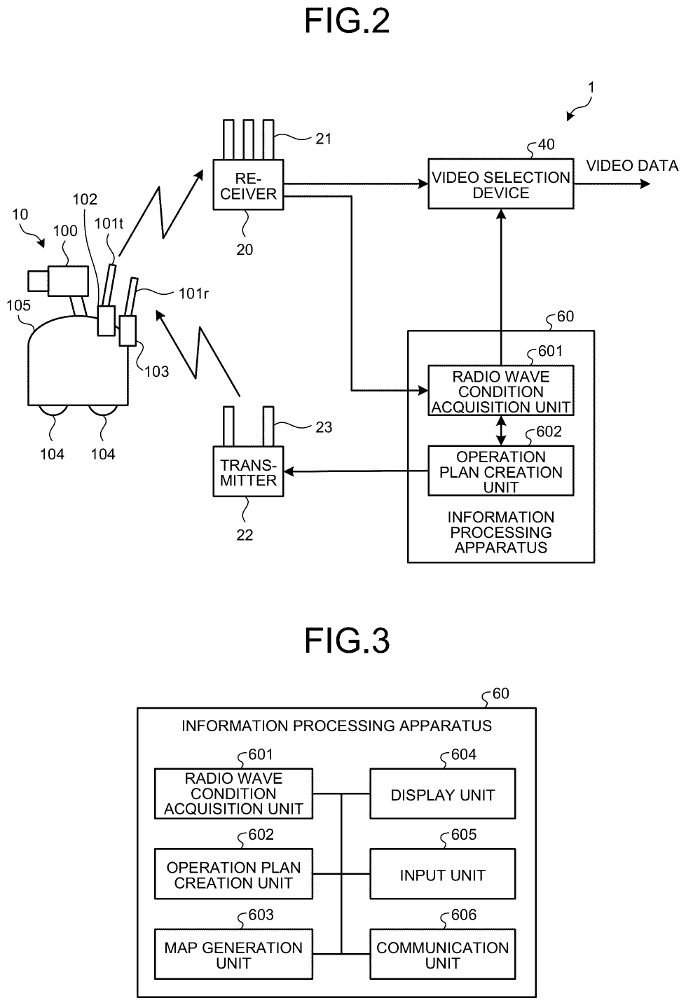

Next, a configuration applicable to an embodiment of the present disclosure will be described. FIG. 2 is a schematic diagram illustrating a configuration of an example of an information processing system as a video distribution system according to the embodiment.

In FIG. 2, an information processing system 1 includes the mobile device 10, a receiver 20, a video selection device 40, an information processing apparatus 60, and a transmitter 22. Note that the stage 50 described with reference to FIG. 1 can be applied as an environment in which the mobile device 10 operates, and thus the description thereof will be omitted here.

The mobile device 10 includes a camera 100 mounted on a housing 105, and includes antennas 101t and 101r, a transmitter 102 and a receiver 103, and a movement mechanism 104. The transmitter 102 of the mobile device 10 transmits a signal including video data captured and obtained by the camera 100 from the antenna 101t with a predetermined signal strength. Here, the mobile device 10 can acquire position information indicating its own position, include the acquired position information in the signal, and transmit the signal. The transmitted signal is received by an antenna 21 and passed to the receiver 20. Furthermore, a signal transmitted from an antenna 23 of the transmitter 22 is received by the antenna 101r and passed to the receiver 103.

Note that, for example, Wireless Fidelity (Wi-Fi) (registered trademark) can be applied as a communication scheme between the mobile device 10 (the transmitter 102 and the receiver 103) and the receiver 20, and between the mobile device 10 and the transmitter 22. The communication scheme between the mobile device 10 and the receiver 20, and between the mobile device 10 and the transmitter 22 is not limited to Wi-Fi. Furthermore, data is transmitted and received between the receiver 20 and the video selection device 40, and between the receiver 20 and the information processing apparatus 60, by using wired or wireless communication. In the case of wireless communication, Wi-Fi can be used.

In addition, here, it has been described that the receiver 103 and the antenna 101r only receive the signal transmitted from the transmitter 22, but this is not limited to this example. For example, the receiver 103 may have a signal transmission function together with a signal reception function, and may be capable of bidirectional communication with the transmitter 22 by a predetermined communication scheme such as Wi-Fi, for example.

In the mobile device 10, the movement mechanism 104 is provided on the bottom surface portion of the housing 105, and is driven by a driving unit (not illustrated) to rotate and move the mobile device 10.

It is assumed here that, for the sake of description, the mobile device 10 includes the antenna 101t that transmits a signal, and the antenna 101r that receives a signal, but this is not limited to this example. For example, the mobile device 10 may transmit and receive signals using one antenna.

The receiver 20 transfers video data received from the mobile device 10 to the video selection device 40. Furthermore, the receiver 20 measures the strength of the signal including the video data received from the mobile device 10 and acquires signal strength information. The receiver 20 transfers the acquired signal strength information to the information processing apparatus 60. Here, the signal strength information can include identification information for identifying the mobile device 10 that has transmitted the signal and position information indicating the position of the mobile device 10.

Hereinafter, unless otherwise specified, “transmitting a signal including video data” is described as “transmitting video data”, “receiving a signal including video data” is described as “receiving video data”, and the like.

The information processing apparatus 60 includes functions of a radio wave condition acquisition unit 601 and an operation plan creation unit 602.

The signal strength information transferred from the receiver 20 is passed to the radio wave condition acquisition unit 601 as a radio wave condition in an environment including the mobile device 10 and the receiver 20. The radio wave condition acquisition unit 601 analyzes the radio wave condition passed from the receiver 20. The radio wave condition includes, for example, signal strength and position information indicating the position where the signal is transmitted. That is, the radio wave condition acquisition unit functions as an acquisition unit that acquires the radio wave condition in the environment. The radio wave condition acquisition unit 601 passes information indicating the analyzed radio wave condition to the operation plan creation unit 602.

The operation plan creation unit 602 creates an operation plan for controlling the movement route and the orientation of the mobile device 10 on the basis of the information indicating the radio wave condition passed from the radio wave condition acquisition unit 601. That is, the operation plan creation unit 602 functions as a creation unit that creates an operation plan on the basis of the radio wave condition and radio field intensity necessary for transmitting video data to be used for distribution. The operation plan creation unit 602 transfers information indicating the created operation plan to the transmitter 22.

The transmitter 22 transmits, from an antenna 73, a signal including the information indicating the operation plan transferred from the information processing apparatus 60. This signal is received by the antenna 101r in the mobile device 10 and imported into the mobile device 10 via the receiver 103. The mobile device 10 controls the movement and rotation operations according to the movement route and the orientation indicated in the operation plan in accordance with the information indicating the imported operation plan.

FIG. 3 is a functional block diagram of an example for explaining functions of the information processing apparatus 60 according to an embodiment. In FIG. 3, the information processing apparatus 60 according to the embodiment includes a radio wave condition acquisition unit 601, an operation plan creation unit 602, a map generation unit 603, a display unit 604, an input unit 605, and a communication unit 606.

The radio wave condition acquisition unit 601, the operation plan creation unit 602, the map generation unit 603, the display unit 604, the input unit 605, and the communication unit 606 are configured by operation of the information processing program according to the embodiment on, for example, a central processing unit (CPU). Not limited to this, some or all of the radio wave condition acquisition unit 601, the operation plan creation unit 602, the map generation unit 603, the display unit 604, the input unit 605, and the communication unit 606 may be configured by hardware circuits that operate in cooperation with each other.

In FIG. 3, the display unit 604 generates screen information, and causes a display included in the information processing apparatus 60 or connected to the information processing apparatus 60 to display a screen in accordance with the generated screen information. The input unit 605 receives an input by the user. The communication unit 606 controls communication with an external device of the information processing apparatus 60. For example, the communication unit 606 controls communication between the information processing apparatus 60 and the video selection device 40, the receiver 20, and the transmitter 22. Furthermore, the communication unit 606 also controls communication with respect to the network.

The radio wave condition acquisition unit 601 acquires the radio wave condition in the environment (for example, on the stage 50) transferred from the receiver 20. For example, the radio wave condition acquisition unit 601 can obtain a radio field intensity distribution in the environment on the basis of the radio wave conditions transmitted from each mobile device 10, and acquire the obtained radio field intensity distribution as the radio wave conditions in the environment.

The operation plan creation unit 602 creates an operation plan for controlling the operation of each mobile device 10 on the basis of the arrangement information of the performer 51 and the equipment and the like 52 on the stage 50, and the radio wave condition acquired by the radio wave condition acquisition unit 601. Here, it is assumed that the arrangement information of the performer 51 and the equipment and the like 52 on the stage 50 is created in advance as two-dimensional or three-dimensional map information by, for example, a director or the like who directs the performance and the like on the stage 50, and is input to the operation plan creation unit 602.

The map generation unit 603 generates a radio wave condition map visualizing the radio wave conditions acquired by a radio wave condition acquisition unit 601. The map generation unit 603 generates, as a radio wave condition map, a map indicating the distribution of the radio field intensity on the basis of the signal strength and the position information included in the radio wave condition, for example. The display unit 604 displays the generated radio wave condition map on the display as a map screen.

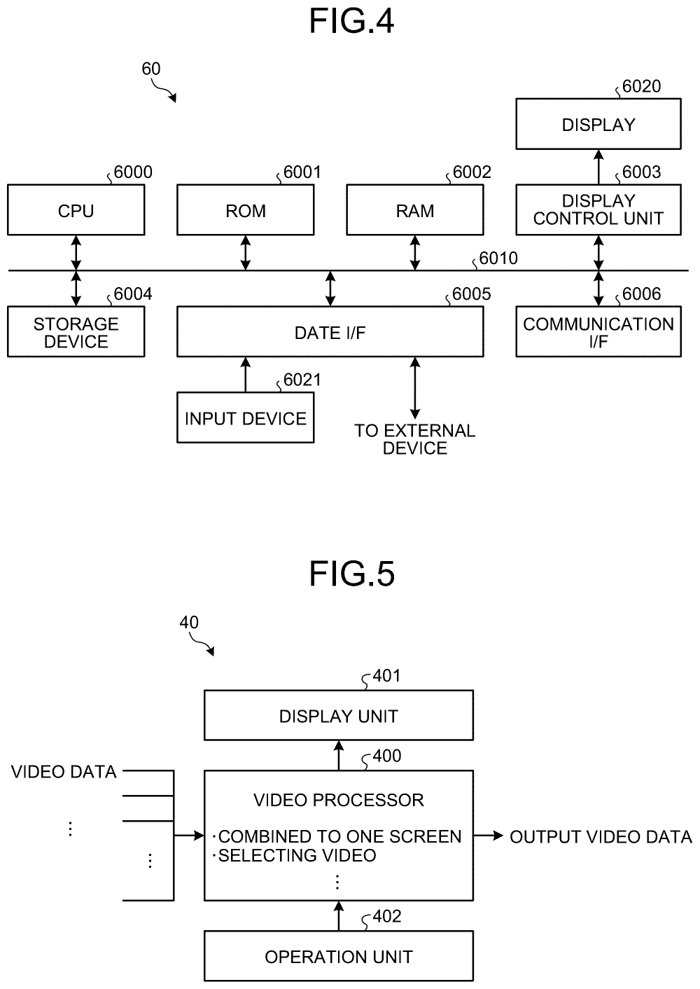

FIG. 4 is a block diagram illustrating an example of a hardware configuration of the information processing apparatus 60 according to an embodiment. In FIG. 4, the information processing apparatus 60 includes a CPU 6000, a read only memory (ROM) 6001, a random access memory (RAM) 6002, a display control unit 6003, a storage device 6004, a data I/F 6005, and a communication I/F6006, which are communicably connected to each other via a bus 6010.

The storage device 6004 is a nonvolatile storage medium such as a hard disk drive or a flash memory. The CPU 6000 operates using the RAM 6002 as a work memory according to a program stored in the ROM 6001 or the storage device 6004, and controls the entire operation of the information processing apparatus 60.

The display control unit 6003 generates a display signal that a display 6020 can display on the basis of a display control signal generated by the CPU 6000 according to the program. The display control unit 6003 supplies the generated display signal to the display 6020. The display 6020 displays a screen in accordance with the supplied display signal.

The data interface (I/F) 6005 is an interface for inputting/outputting data to/from an external device. In this example, an input device 6021 including a pointing device such as a mouse and a keyboard is connected to the data I/F 6005. The present invention is not limited thereto, and the input device 6021 may be a fair device built in the information processing apparatus 60. The communication I/F 6006 controls communication with respect to the network.

Communication between the information processing apparatus 60 and the video selection device 40, the receiver 20, and the transmitter 22 is performed by appropriately using data I/F 6005 and communication I/F 6006.

In the information processing apparatus 60, the CPU 6000 executes the information processing program according to the embodiment to configure each of the radio wave condition acquisition unit 601, the operation plan creation unit 602, the map generation unit 603, the display unit 604, the input unit 605, and the communication unit 606 described above on a main storage area in the RAM 6002 as, for example, a module.

The information processing program can be acquired from the outside (for example, a server) via a network such as a LAN or the Internet by communication via the communication I/F 6006, for example, and can be installed on the information processing apparatus 60. The present invention is not limited thereto, and the information processing program may be provided by being stored in a detachable storage medium such as a compact disk (CD), a digital versatile disk (DVD), or a universal serial bus (USB) memory.

Note that, in the above description, it has been described that single information processing apparatus 60 includes the function of the radio wave condition acquisition unit 601 and the function of the operation plan creation unit 602, however, the present invention is not limited to this example. For example, the present invention can be configured so that the function of the radio wave condition acquisition unit 601 and the function of the operation plan creation unit 602 can be included in individual information processing apparatuses connected to communicate with each other.

FIG. 5 is a functional block diagram of an example for explaining functions of a video selection device 40 applicable to an embodiment. In FIG. 5, the video selection device 40 includes a video processor 400, a display unit 401, and an operation unit 402.

The display unit 401 displays a screen on the display according to the display signal output from the video processor 400. The operation unit 402 receives a user operation and passes a control signal corresponding to the user operation to the video processor 400.

A plurality of pieces of video data is input to the video processor 400. The video processor 400 performs composite processing for displaying each input video of the plurality of pieces of input video data and an output video to be output from the video processor 400 on one screen. The video processor 400 transfers, to the display unit 401, a display signal for displaying the screen combined by the composite processing on the display.

In addition, the video processor 400 outputs, from the video selection device 40, video data of a video selected from each input video by a user operation or the like on the operation unit 402 as output video data. Moreover, the video processor 400 can perform predetermined effect processing on the video data of the video selected from each input video according to the user operation on the operation unit 402.

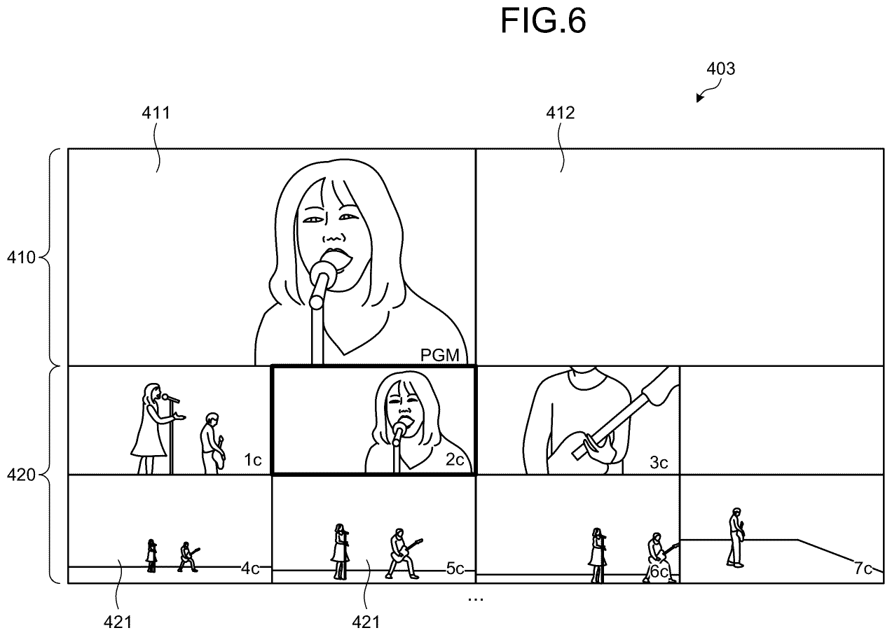

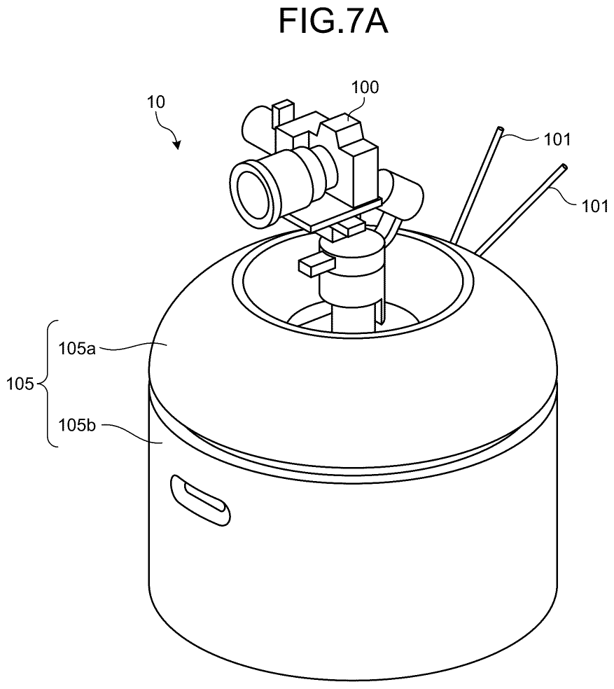

FIG. 6 is a schematic diagram illustrating an example of a video selection screen to be displayed on a display by the display unit 401 of the video selection device 40, which can be applied to an embodiment.

In FIG. 6, a video selection screen 403 includes an output video display area 410 and an input video display area 420. In this example, the output video display area 410 includes a display area 411 in which the video being output is displayed and a display area 412 in which the video of the output candidate is displayed.

On the other hand, the input video display area 420 includes a plurality of display areas 421 in which input videos captured by different cameras are displayed. In this example, the input video display area 420 includes a plurality of (eight in this example) display areas 421, and the plurality of input videos can be simultaneously confirmed. In this example of FIG. 6, the input video display area 420 includes eight display areas 421, and eight input videos can be simultaneously confirmed. In addition, nine or more input videos can be handled, for example, by switching the display of the input video display area 420. The number of display areas 421 included in the input video display area 420 is not limited to eight, and may be seven or less, or nine or more. Furthermore, in this example, videos from seven cameras identified by the camera IDs [1c] to [7c] are displayed in each display area 421 as input videos.

The user can designate the video to be output from each input video displayed in the input video display area 420 by operating the operation unit 402. In the example of the drawing, as illustrated by adding a thick frame to the display area 421, the input video by the camera ID [2c] is designated as the video to be output. In the output video display area 410, in the display area 411, the video by the camera ID [2c] designated in the input video display area 420 is displayed as the output video being output.

In the display area 412, a video desired to be output next to the output image displayed in the display area 411 is displayed. Furthermore, the video processor 400 can apply a predetermined effect to the output video displayed in the display area 411, for example, according to a user operation on the operation unit 402. In addition, when switching the output video from the video displayed in the display area 411 to the video displayed in the display area 412, the video processor 400 can apply a transition effect accompanying the switching of the output video, such as cross-fade processing.

Note that the video selection device 40 can include, as a hardware configuration, a CPU, a digital signal processor (DSP), a RAM, a storage device, an interface corresponding to a plurality of pieces of video data, and the like.

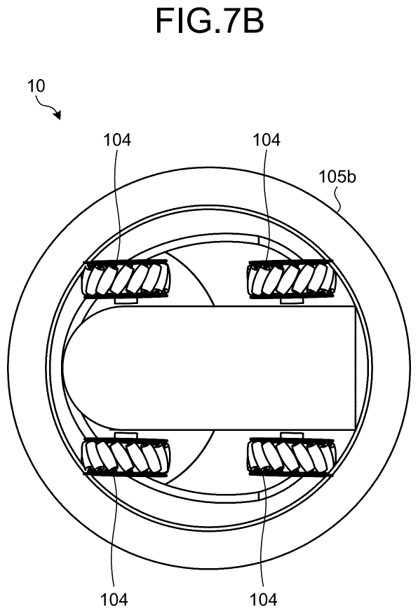

And FIG. 7B is a schematic diagram illustrating an example of an appearance of the mobile device 10 applicable to an embodiment. FIG. 7A is a perspective view illustrating an appearance of the mobile device 10, and FIG. 7B is a view of the mobile device 10 as viewed from a bottom surface side.

The mobile device 10 illustrated in FIG. 7A has an appearance shape close to a cylindrical shape. The housing 105 which is an outer housing includes an upper housing 105a and a lower housing 105b. A gap is provided between the upper housing 105a and the lower housing 105b. A sensor that recognizes the surrounding environment is provided at the same height as the gap. The gap is formed so as not to disturb recognition by the sensor.

An opening is formed in an upper portion of the upper housing 105a so that imaging by the camera 100 is not hindered. The camera 100 is provided to be rotatable in the horizontal direction with respect to the housing 105. Furthermore, an antenna 101 is provided at a predetermined position of the upper housing 105a so that imaging by the camera 100 is not hindered. Here, the antenna 101 integrates the functions of the antennas 101t and 101r described above. At least the antenna 101t of the antennas 101t and 101r is provided, for example, on a part of the periphery of the housing 105.

In FIG. 7B, the movement mechanism 104 moves the mobile device 10 in an arbitrary direction on the stage 50 and rotates the mobile device 10. In the example illustrated in FIG. 7B, the movement mechanism 104 includes a plurality of rollers. The roller is incorporated in, for example, a carriage or the like (not illustrated) and abuts on the stage 50 through an opening formed below the lower housing 105b. The movement mechanism 104 may be configured to include, for example, a mecanum wheel or the like to enable omnidirectional movement and rotation of the mobile device 10. As a result, the mobile device 10 can come out of a state of being sandwiched by a person without unnecessary rotation or can freely take a position in complicated equipment.

Note that the mobile device 10 can independently control an orientation of the housing 105 (assuming that a direction in which the antenna 101 is provided is a rear side) and a capturing direction of the camera 100. That is, the mobile device 10 can move and rotate the housing 105 while maintaining the direction of capturing a video by the camera 100.

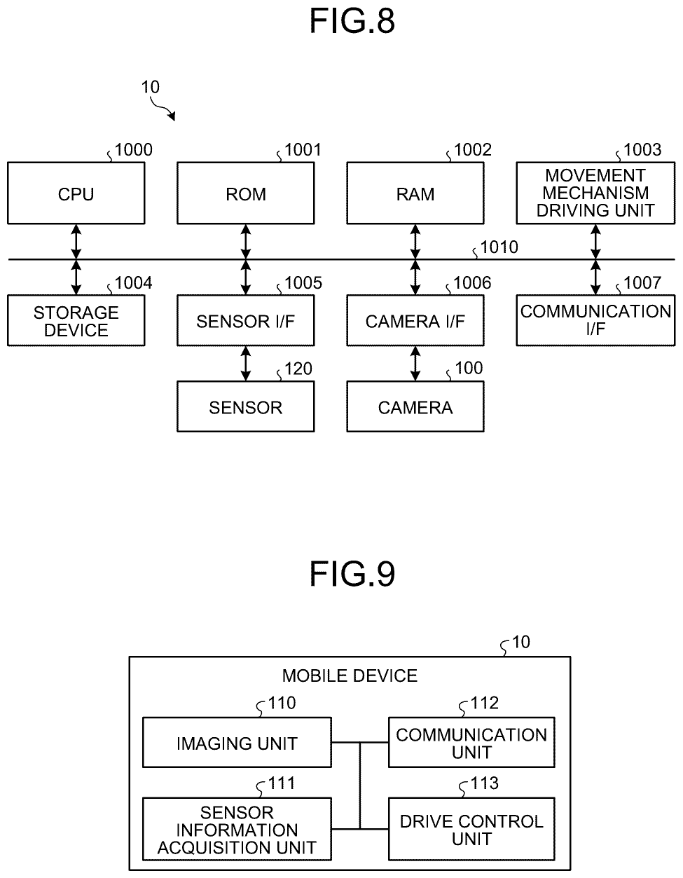

FIG. 8 is a block diagram illustrating an example of a hardware configuration of a mobile device 10 applicable to an embodiment. In FIG. 8, the mobile device 10 includes a CPU 1000, a ROM 1001, a RAM 1002, a movement mechanism driving unit 1003, a storage device 1004, a sensor I/F 1005, a camera I/F 1006, and a communication I/F 1007 which are communicably connected to each other by a bus 1010.

The storage device 1004 is a nonvolatile storage medium such as a hard disk drive or a flash memory. The CPU 1000 controls, using the RAM 1002 as a work memory according to a program stored in the ROM 1001 or the storage device 1004, the entire operation of this mobile device 10.

The movement mechanism driving unit 1003 includes a power source such as a motor and a drive circuit for driving the power source, and drives the movement mechanism 104 in accordance with an instruction from the CPU 1000. The sensor I/F 1005 is an interface for a sensor 120, and transfers a sensor output signal output from the sensor 120 to the bus 1010. The sensor 120 includes at least a position sensor that acquires the current position of the mobile device 10. The sensor 120 may acquire the current position by combining a gyro sensor, an acceleration sensor, and the like, or may acquire the current position by communication using Wi-Fi (registered trademark), a predetermined beacon, or the like.

The camera I/F 1006 is an interface for the camera 100, and transmits and receives various data such as video data, capturing control data, and status information to and from the camera 100. The communication I/F 1007 controls communication by the transmitter 102 and the receiver 103.

FIG. 9 is a functional block diagram of an example for explaining functions of the mobile device 10 applicable to an embodiment.

In FIG. 9, the mobile device 10 includes an imaging unit 110, a sensor information acquisition unit 111, a communication unit 112, and a drive control unit 113. The imaging unit 110, the sensor information acquisition unit 111, the communication unit 112, and the drive control unit 113 are configured by, for example, executing a program on a CPU. The present invention is not limited thereto, and the imaging unit 110, the sensor information acquisition unit 111, the communication unit 112, and the drive control unit 113 may be configured by hardware circuits that operate in cooperation with each other.

The imaging unit 110 controls a capturing operation by the camera 100. The sensor information acquisition unit 111 acquires sensor information based on a sensor output signal from the sensor 120. For example, the sensor information acquisition unit 111 acquires position information indicating at least the current position of the mobile device 10 on the basis of the sensor output signal.

The communication unit 112 controls transmission processing by the transmitter 102 and reception processing by the receiver 103 via the communication I/F 1007.

The drive control unit 113 generates a control signal for driving the movement mechanism 104 and passes the control signal to the movement mechanism driving unit 1003. For example, the drive control unit 113 receives, from the communication unit 112, operation plan data indicating the operation plan created by the operation plan creation unit 602 in the information processing apparatus 60. The drive control unit 113 generates a drive signal for driving the movement mechanism 104 according to the received operation plan data. In this manner, the mobile device 10 performs autonomous movement based on the operation plan.

Note that the mobile device 10 stores the received operation plan data in the storage device 1004 or the RAM 1002. If newly receiving operation plan data, the mobile device 10 may overwrite the already stored operation plan data with the newly received operation plan data.

### 3. First Embodiment

Next, a first embodiment of the present disclosure will be described.

In the first embodiment, an operation plan creation unit 602 of an information processing apparatus 60 creates an operation plan of a mobile device 10 on the basis of the radio wave conditions acquired by a radio wave condition acquisition unit 601. At this time, based on the radio wave conditions, the operation plan creation unit 602 creates an operation plan for the mobile device 10 so that the mobile device 10 moves while avoiding an area where the radio field intensity is equal to or lower than the threshold such that the video data transmitted from the mobile device 10 can be received by the receiver 20 without interruption.

Furthermore, the information processing apparatus 60 visualizes the radio wave conditions by a map generation unit 603 and presents the radio wave conditions to the user. At this time, the map generation unit 603 explicitly presents an area where the radio field intensity is equal to or lower than the threshold with respect to the visualized radio wave conditions.

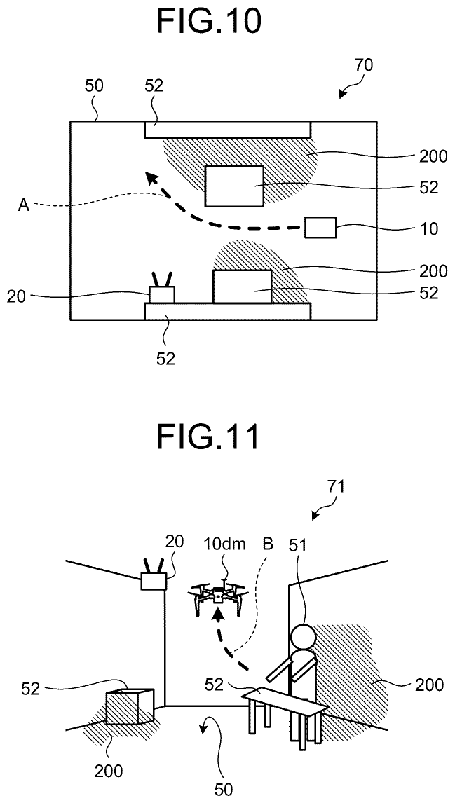

FIG. 10 is a schematic diagram illustrating an example of a visualization screen 70 displaying visualization of radio wave conditions and a movement route of the mobile device 10 based on an operation plan according to the first embodiment.

As illustrated in FIG. 10, it is assumed that the mobile device 10 is initially located on the right end side in the drawing of the stage 50. An area in which the radio field intensity is equal to or less than the threshold is generated by the equipment and the like 52 disposed between the mobile device 10 and the receiver 20. In the example of FIG. 10, the map generation unit 603 visualizes, on the visualization screen 70, an area in which the radio field intensity is equal to or lower than the threshold, that is, an area in which there is a high possibility that the video based on the transmitted video data is interrupted or disturbed when the video data is transmitted, as a danger area 200.

In addition, the map generation unit 603 displays a route A according to the operation plan created by the operation plan creation unit 602 on the visualization screen 70. As illustrated in FIG. 10, the route A is set while avoiding the danger area 200.

Note that the map generation unit 603 sequentially updates the position of the mobile device 10 on the visualization screen 70 as the mobile device 10 moves on the stage 50. In addition, the map generation unit 603 sequentially updates the display of the danger area 200 even when the radio wave condition changes.

Further, the map generation unit 603 may cause the visualization screen 70 to display the danger area 200 based on the radio wave condition estimated from the relationship of the structure of the environment such as the positional relationship between the equipment and the like 52 arranged on the stage 50 and the antenna 20. As an example, it can be estimated that the radio wave condition is good in an area where there is no shielding with respect to the radio wave transmitted from the antenna 20. On the other hand, in an area where the radio wave transmitted from the antenna 20 is shielded, it can be estimated that the radio wave condition is slightly deteriorated, and the map generation unit 603 can display such an area as the danger area 200.

FIG. 11 is a schematic diagram illustrating an example in which the visualization screen according to the first embodiment is applied to a screen representing a three-dimensional space. For example, in a case where the user wears a so-called see-through type head-mounted display (augmented reality (AR) glasses) that transmits an image of the real space, a display indicating the danger area 200 can be superimposed on the image of the stage 50 that appears to transmit the AR glasses.

Note that, here, for the sake of convenience, the glass portion in the AR glasses will be referred to as a screen, and the description will be given assuming that the image seen in the user's eye through the glass portion is an image displayed on the screen. Furthermore, it is assumed that the camera (not illustrated) is mounted on a mobile device 10drn (for example, a drone) that can freely move up, down, left, right, front, and back in the real space and can stay in the real space.

In the example of FIG. 11, a visualization screen 71 displayed for the AR glasses includes a performer 51 and the equipment and the like 52, which are images in the real space, and also includes the display of the danger area 200 generated by the map generation unit 603. In this example, the performer 51 on the right side of the visualization screen 71 and the equipment and the like 52 on the left side generate area in which the radio field intensity is equal to or less than the threshold, and each area is displayed as the danger area 200.

In addition, the map generation unit 603 causes the visualization screen 71 to display a route B including the height information in the three-dimensional space according to the operation plan created by the operation plan creation unit 602. In this example, as illustrated in FIG. 11, the route B is also set while avoiding the danger area 200.

As described above, the information processing apparatus 60 according to the embodiment explicitly presents the danger area 200 in which there is a high possibility that the video based on the transmitted video data is interrupted on the visualization screen 70 or 71 on the basis of on the radio field intensity. As a result, the user can easily confirm that the mobile device 10 or 10drn is moving so as not to cause interruption or disturbance of the video based on the video data to be transmitted.

Furthermore, it is also conceivable that the user manually operates the mobile device 10 or 10′. Even in this case, since the danger area 200 is explicitly displayed on the visualization screen 70 or 71′, it is easy to operate the mobile device 10 or 10′ so as not to cause interruption or disturbance of the video based on the video data to be transmitted.

### 3-1. First Modification of First Embodiment

Next, a first modification of the first embodiment will be described. In the information processing apparatus 60 according to the first modification of the first embodiment, the user can designate a level to which radio field intensity evaluated as an absolute value is allowed on a visualization screen including visualization information based on a radio wave condition. In the information processing apparatus 60, the operation plan creation unit 602 determines a route of the mobile device 10 according to the level of the radio field intensity designated by the user, and creates an operation plan.

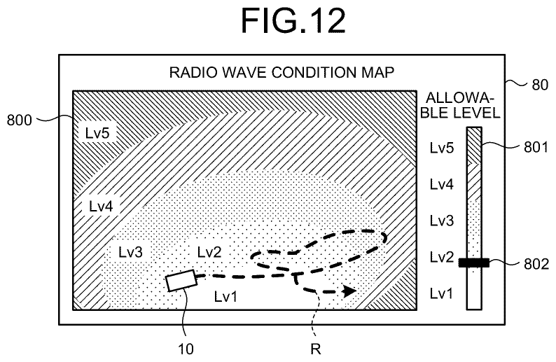

FIG. 12 is a schematic diagram illustrating an example of a visualization screen 80 according to the first modification of the first embodiment.

In FIG. 12, the visualization screen 80 includes a radio wave condition map 800. In the example of FIG. 12, the radio wave condition map 800 visualizes the distribution of the radio field intensity on the stage 50 by contour display.

As an example, for example, prior to the start of capturing a video by the mobile device 10, the user measures the radio field intensity at each position while moving the mobile device 10 on the stage 50 in a state where the performer 51 and the equipment and the like 52 are arranged on the stage 50. The measured radio field intensity at each position is input to the information processing apparatus 60 in association with the measurement position, and is passed to, for example, the radio wave condition acquisition unit 601.

The radio wave condition acquisition unit 601 normalizes the passed radio field intensity at each position by a predetermined method, and classifies the normalized radio field intensity at each position for each level. For example, the radio wave condition acquisition unit 601 classifies each normalized radio field intensity into five groups according to the value. Among the groups classified into the five levels, the radio wave condition acquisition unit 601 sets a group having the largest value of the radio field intensity as a level Lv1, a group having the smallest value of the radio field intensity as a level Lv5, and sets intermediate groups thereof as levels Lv4, Lv3, and Lv2 in ascending order of the values.

The map generation unit 603 generates the radio wave condition map 800 by contour line display corresponding to each level illustrated in FIG. 12 on the basis of the radio field intensity at each position classified into levels Lv1 to Lv5 by the radio wave condition acquisition unit 601. In the example of FIG. 12, each area corresponding to each of the levels Lv1 to Lv5 is painted with a density corresponding to the level. For example, in the example of the radio wave condition map 800 in FIG. 12, the darkest painted area is the area of level Lv5, and the unpainted area is the area of Lv1.

In the example of FIG. 12, in the radio wave condition map 800, the mobile device 10 and a route R according to the operation plan for the mobile device 10 are displayed in a superimposed manner with respect to the radio field intensity display.

In the visualization screen 80 of FIG. 12, a slider 801 arranged on the right side can designate the allowable level for the radio field intensity by operating a knob 802. The allowable level for the radio field intensity indicates a level of radio field intensity allowed for transmission of video data by the mobile device 10. For example, the operation plan creation unit 602 creates the operation plan of the mobile device 10 using the radio field intensity at the specified allowable level as the lower limit of the radio field intensity at the time of transmitting the video data.

Here, the radio field intensity is classified into discrete values in five levels to generate the radio wave condition map 800, but this is not limited to this example. For example, the radio field intensity may be classified into finer levels to generate the radio wave condition map 800, or it is also possible to treat the radio field intensity as analog information and generate the radio wave condition map 800 using gradation or the like with the electric field intensity as a continuous value.

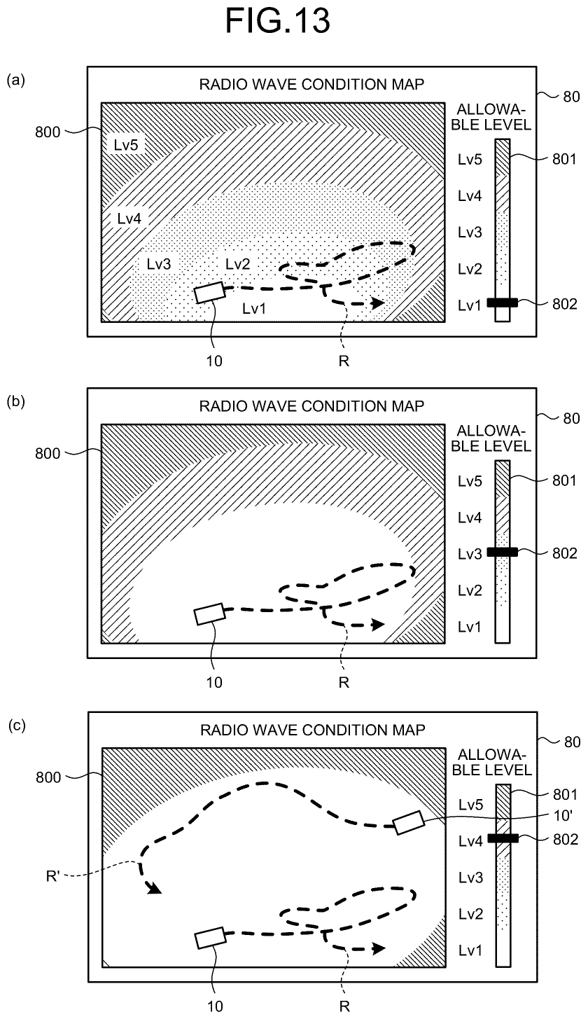

FIG. 13 is a schematic diagram illustrating an example of an operation on the slider 801 on the visualization screen 80 according to the first modification of the first embodiment. In FIG. 13, sections (a), (b), and (c) illustrate an example in which the knob 802 is moved to the positions of levels Lv1, Lv3, and Lv4, respectively. In each radio wave condition map 800, it can be seen that the radio wave condition map 800 is updated according to the position of the knob 802, and the filled area is changed. In the radio wave condition map 800, an area at the level designated by the knob 802, that is, an unfilled area is an area where the mobile device 10 is moved according to the operation plan.

In the example of the section (a) of FIG. 13, the level Lv1 is set as an allowable level, and only the area of the radio field intensity corresponding to the level Lv1 is set as an area that is not filled. On the other hand, the route R of the mobile device 10 goes beyond the area of the level Lv1 which is the allowable level. For example, the operation plan creation unit 602 can prevent creation of such an operation plan by the route R that goes beyond the area indicated by the allowable level.

On the other hand, in the example of the section (b) of FIG. 13, the level Lv3 is set as an allowable level, and the area corresponding to the allowable level is enlarged as compared with the example of the section (a). The operation plan creation unit 602 can create an operation plan by the route R of the mobile device 10 within the area indicated by the enlarged allowable level. On the other hand, in this case, since the route R according to the operation plan is set to include the area of the level Lv3 where the radio field intensity is lower than the level Lv1, there is a risk that interruption or disturbance may occur in the video based on the video data transmitted from the mobile device 10.

In the example of the section (c) in FIG. 13, the level Lv4 is set as an allowable level, and the area according to the culture level is further enlarged as compared with the example of the section (b). The operation plan creation unit 602 can create an operation plan by the route R of the mobile device 10 and create a new operation plan by a route R′ of another mobile device 10′, for example, within the area indicated by the enlarged allowable level. In this case, the route R′ according to the new operation plan is set including the area of the level Lv4 in which the radio field intensity is lower than the level Lv3. Therefore, the risk of occurrence of interruption or disturbance in the video based on the video data transmitted from the mobile device 10 is further increased as compared with the example of the section (b).

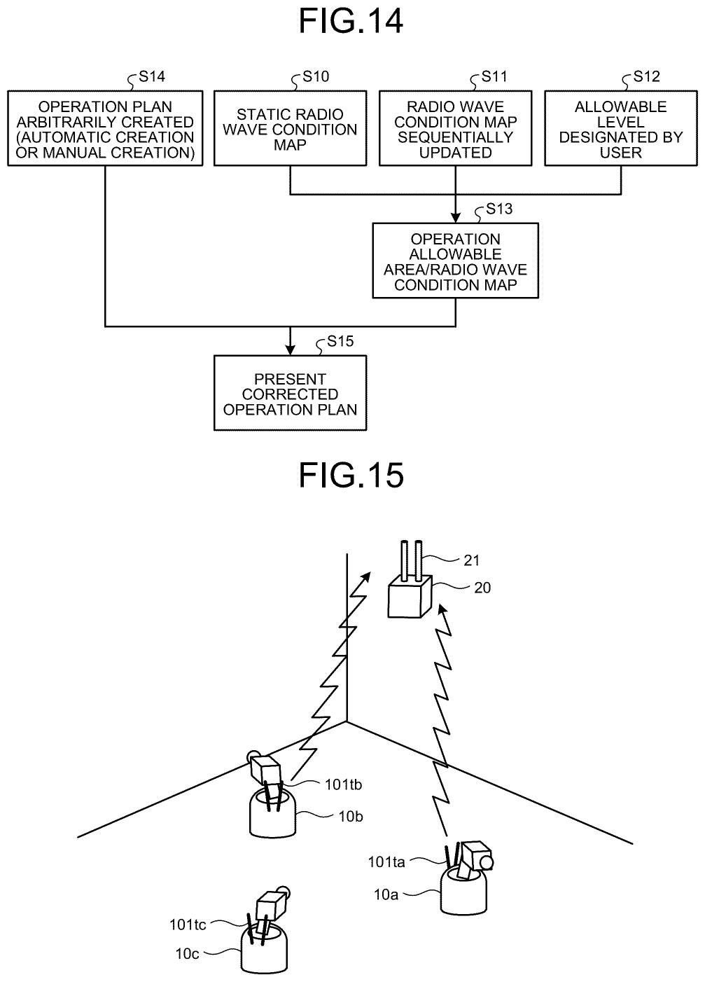

FIG. 14 is a schematic diagram for explaining generation of the radio wave condition map 800 and creation of an operation plan according to the first modification of the first embodiment. For example, as described above, the map generation unit 603 generates the radio wave condition map on the basis of the radio field intensity at each position on the stage 50 acquired prior to the capturing by the mobile device 10 (step S10). The radio wave condition map generated here is a static radio wave condition map in an initial state.

In addition, the map generation unit 603 generates the radio wave condition map on the basis of the position information and the radio field intensity acquired from the mobile device 10 that is capturing and moving (step S11). The radio wave condition map is sequentially updated in accordance with capturing and movement of the mobile device 10.

Further, the map generation unit 603 acquires an allowable level designated by the user using the slider 801 on the visualization screen 80 (step S12).

The map generation unit 603 generates and updates the radio wave condition map 800 on the basis of the static radio wave condition maps, the sequentially updated radio wave condition maps, and the allowable level designated by the user (step S13). Here, the map generation unit 603 presents an area allowing the operation of the mobile device 10 in the radio wave condition map 800.

The operation plan creation unit 602 acquires an operation plan by automatic creation or manual creation (step S14). The operation plan creation unit 602 corrects the operation plan acquired in step S14 on the basis of the radio wave condition map 800 generated by the map generation unit 603 in step S13. For example, the map generation unit 603 reflects the operation plan corrected by the operation plan creation unit 602 in the radio wave condition map 800, for example, as a route of the mobile device 10, and presents the operation plan to the user.

In the corrected operation plan, the movement range of the mobile device 10 is limited according to the allowable level in the radio wave condition map 800 with respect to the initial operation plan acquired in step S14. As an example, in a case where it is desired to cause the mobile device 10 to reciprocate equally in front of the performer 51 to the left and right in order to capture the performer 51, it is conceivable to set a restriction so that the mobile device 10 does not come out of the area based on the allowable level.

As described above, according to the first modification of the first embodiment, the area where the mobile device 10 is moved can be set on the basis of the radio wave condition map 800. As a result, the user can more freely set the area where the mobile device 10 is moved while suppressing the risk that the video is interrupted.

### 3-2. Second Modification of First Embodiment

Next, a second modification of the first embodiment will be described. The second modification of the first embodiment is an example in which the orientation of the mobile device 10 is further controlled.

FIG. 15 is a diagram for explaining that the state of radio waves transmitted from the mobile device 10 differs depending on the orientation of the mobile device 10. In FIG. 15, mobile devices 10a, 10b, and 10c include antennas 101ta, 101tb, and 101tc for transmitting video data, respectively. In the example of FIG. 15, in the mobile devices 10a and 10b, there is no shielding object with respect to the radio wave between each of the antennas 101ta and 101tb and the receiver 20. Therefore, the receiver 20 can receive the signals transmitted from the mobile devices 10a and 10b without any problem.

On the other hand, in the mobile device 10c, the antenna 101tc is directed in the direction opposite to the receiver 20 with respect to the mobile device 10c. Therefore, the signal transmitted from the antenna 101tc may not be received by the receiver 20 with sufficient signal strength because the mobile device 10c itself becomes a shielding object. Therefore, in the second modification of the first embodiment, the autonomous movement by the mobile device 10 is optimized so that the antenna 101t faces the direction of the receiver 20 as much as possible.

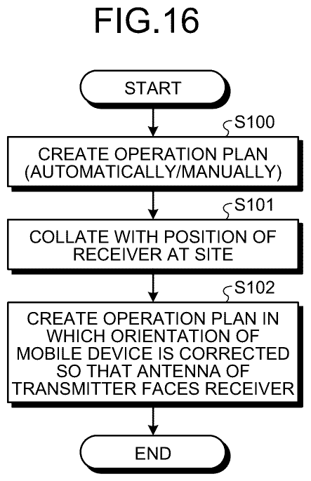

FIG. 16 is a flowchart of an example illustrating creation processing of an operation plan according to the second modification of the first embodiment. In step S100, the operation plan creation unit 602 creates an operation plan automatically or manually. In the next step S101, the operation plan creation unit 602 collates the known position of the receiver 20 for receiving the video data installed at the site (for example, the stage 50) with the position of the mobile device 10 based on the operation plan created in step S100.

In the next step S102, the operation plan creation unit 602 creates an operation plan in which the orientation of the mobile device 10 is corrected on the basis of the result of collation between the position of the receiver 20 and the position of the mobile device 10 according to the operation plan in step S101. More specifically, in the operation plan created in step S100, the operation plan creation unit 602 corrects the orientation of the mobile device 10 (housing 105) so that the antenna 101t of the transmitter 102 that transmits the video data in the mobile device 10 faces the receiver 20.

As described above, in the second modification of the first embodiment, the operation plan creation unit 602 creates the operation plan for the mobile device 10 so that the antenna 101t for transmitting the video data always faces the direction of the receiver 20 when the mobile device 10 moves while capturing a video. Therefore, the mobile device 10 itself is prevented from becoming a shield of a signal for transmitting the video data, and the video data can be stably transmitted.

### 4. Second Embodiment

Next, a second embodiment of the present disclosure will be described. In the second embodiment, the route of a mobile device 10 according to the operation plan is divided according to the radio wave condition, and the operation is taken over from the mobile device 10 to another mobile device 10 at the division position.

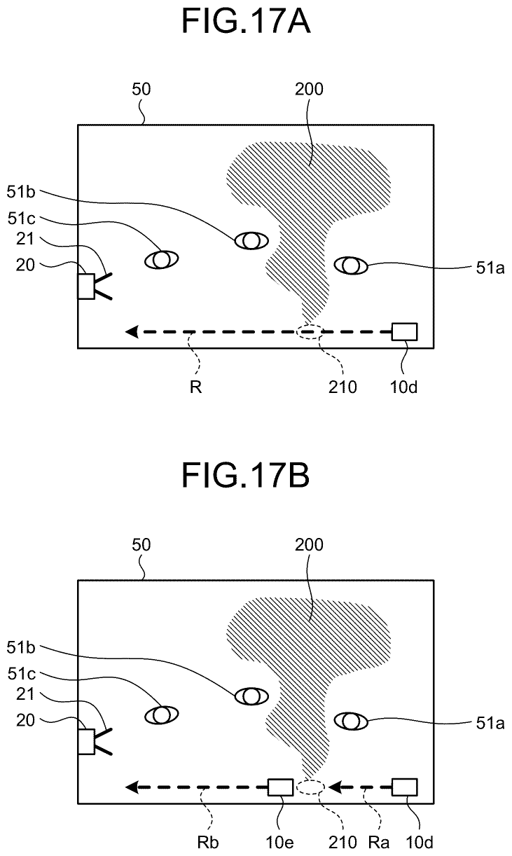

FIGS. 17A and 17B are diagrams for explaining route division and takeover of operation of the mobile device 10 according to the second embodiment. In FIG. 17A, it is assumed that three performers 51a, 51b, and 51c are arranged on a stage 50, and a case where the performers 51a, 51b, and 51c are sequentially captured on video from the right to the left in the drawing will be considered. In this case, if there is no obstacle to the movement of a mobile device 10d and the reception of the video data transmitted from the mobile device 10d, the operation plan is based on, for example, the route R on which the mobile device 10d moves from right to left on the stage 50.

Here, as illustrated in FIG. 17A, it is assumed that a danger area 200 is close to a portion where the mobile device 10d moves from the performer 51a to the performer 51b in the route R. In this case, when the mobile device 10d passes through a space 210 between the danger area 200 and the end (the lower end in the drawing) of the stage 50, there is a possibility that the video based on the video data transmitted from the mobile device 10d is interrupted. Furthermore, in a case where the mobile device 10d autonomously moves, passing through the space 210 at the end of the stage 50 is dangerous for the operation itself of the mobile device 10d.

Therefore, as illustrated in FIG. 17B, an operation plan creation unit 602 creates, for the mobile device 10d, an operation plan by a route Ra on which the mobile device 10d moves to before the danger area 200. Furthermore, the operation plan creation unit 602 creates an operation plan by a route Rb from a position beyond the danger area 200 for a mobile device 10e different from the mobile device 10d.

That is, the operation plan creation unit 602 divides the route R illustrated in FIG. 17A at a position close to the danger area 200 and corresponding to the space 210 that is narrow for the mobile device 10d to pass through, and creates an operation plan using the routes Ra and Rb obtained from dividing the route R. By the operation plan by the route Ra and the operation plan by the route Rb, the operation by the mobile device 10d is taken over to the mobile device 10e.

As described above, even in a case where the mobile device 10d crosses the danger area 200 or approaches the danger area 200, it is possible to avoid a situation in which the video based on the video data obtained by capturing the performers 51a to 51c is interrupted by causing the mobile device 10e to take over the operation of the mobile device 10d. In addition, even when the route R includes an area with a risk of the mobile device 10d for passing through, it is possible to reduce the risk associated with movement by causing the mobile device 10e to take over the operation of the mobile device 10d across the area.

Furthermore, in a case where the operation by the mobile device 10d is taken over to the mobile device 10e as described above, it is also possible to control the video selection device 40 to connect the video data transmitted from the mobile device 10d and the video data transmitted from the mobile device 10e.

That is, since the operation plan creation unit 602 can communicate with the mobile device 10 to know the current position of the mobile device 10, it is possible to accurately grasp the timing at which the operation is taken over from the mobile device 10d to the mobile device 10e. The operation plan creation 602 can instruct the video selection device 40 to automatically switch between the input video from the mobile device 10d and the input video from the mobile device 10e by using the information indicating the takeover timing.

Furthermore, for example, the operation plan creation unit 60 can integrate the respective video data transmitted from the mobile devices 10d and 10e using the information indicating the timing as if the video data is virtually video data captured by one camera, for example, at a preceding stage of the video selection device 40. Video data obtained by integrating the respective video data transmitted from the mobile devices 10d and 10e is input to the video selection device 40. In this way, for example, the user who operates the video selection device 40 can perform switching and editing work of the input video without being conscious of the takeover of the operation from the mobile device 10d to the mobile device 10e.

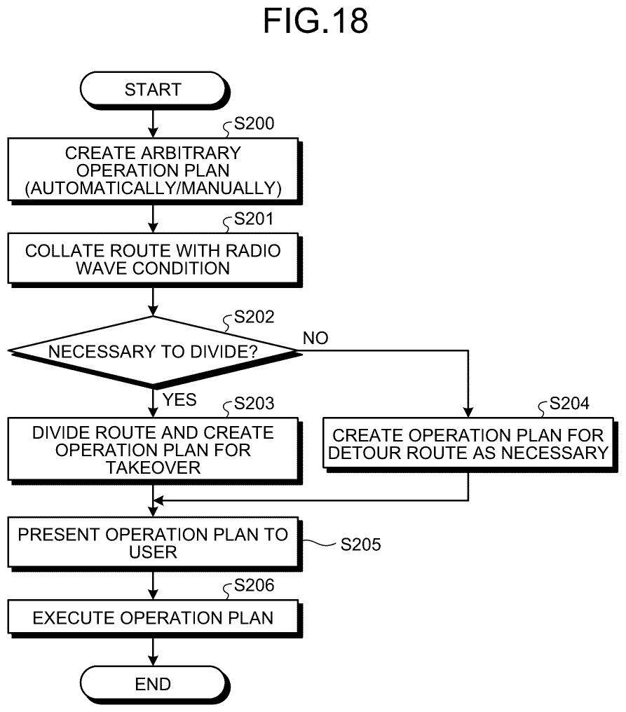

FIG. 18 is a flowchart illustrating an example of creation processing of an operation plan according to the second embodiment. In step S200, the operation plan creation unit 602 creates an operation plan automatically or manually. In the next step S201, the operation plan creation unit 602 collates the route R according to the operation plan created in step S200 with the radio wave condition acquired by the radio wave condition acquisition unit 601.

In the next step S202, the operation plan creation unit 602 determines whether or not it is necessary to divide the route R on the basis of the collation result between the route R according to the operation plan and the radio wave conditions in step S201. For example, in a case where the route R crosses the danger area 200 based on the radio wave condition or approaches the danger area 200 by a predetermined distance or less, or in a case where the route R includes a portion having a width of a predetermined width or less, the operation plan creation unit 602 can determine that it is necessary to divide the route R.

When the operation plan creation unit 602 determines that it is necessary to divide the route R in step S202 (Step S202, “Yes”), the process proceeds to step S203. In step S203, the operation plan creation unit 602 divides the route R into the routes Ra and Rb, and creates an operation plan for taking over the operation from the mobile device 10d to the mobile device 10e for each of the mobile devices 10d and 10e.

On the other hand, when the operation plan creation unit 602 determines that it is not necessary to divide the route R in step S202 (Step S202, “No”), the process proceeds to step S204. In step S204, the operation plan creation unit 602 creates an operation plan for a detour route as necessary. For example, it is conceivable that the operation plan creation unit 602 creates an operation plan by a detour route in a case where there is a route farther from the danger area 200 or a route with a wider width without changing the capturing target with respect to the original route R.

After the process of step S203 or step S204, the operation plan creation unit 602 shifts the process to step S205. In step S205, the operation plan creation unit 602 presents the operation plan created in step S203 or step S204 to the user using, for example, screen display. When the presented operation plan is approved by the user, the operation plan creation unit 602 shifts the process to step S206 and executes the operation plan created in step S203 or step S204.

### 5. Third Embodiment

Next, a third embodiment of the present disclosure will be described. In the third embodiment, a video selection screen 403 of a video selection device 40 is caused to display the signal strength of the video data transmitted from each of mobile devices 10 and the information indicating the transition of the signal strength.

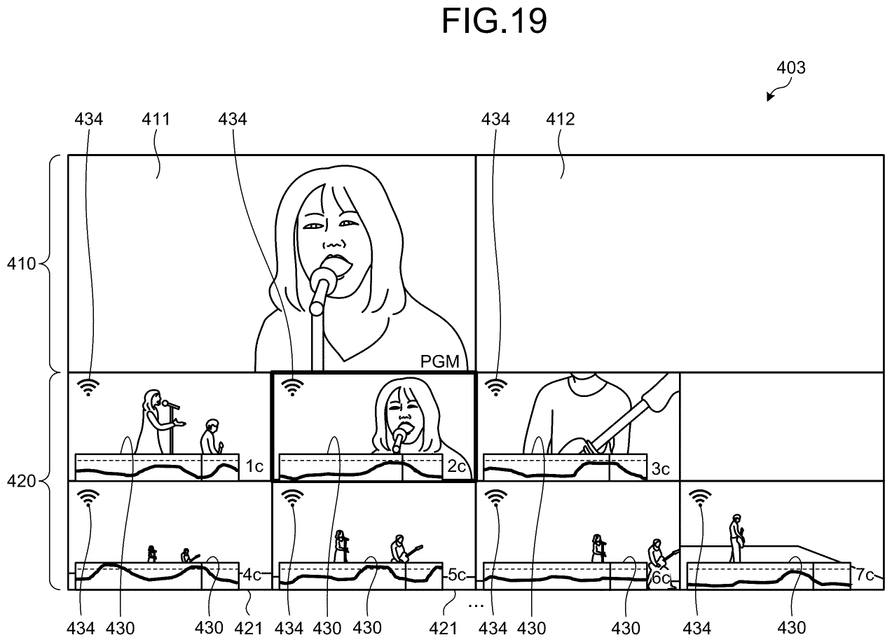

FIG. 19 is a schematic diagram illustrating an example of the video selection screen 403 by the video selection device 40 according to the third embodiment. In the example of FIG. 19, an indicator 434 indicating the signal strength of the video data transmitted from the corresponding mobile device 10 and a transition display 430 including information indicating the transition of the signal strength of the video data are arranged for each display area 421 on the video selection screen 403. The transition display 430 is overlaid on the video displayed in the display area 421 with a predetermined transmittance, for example.

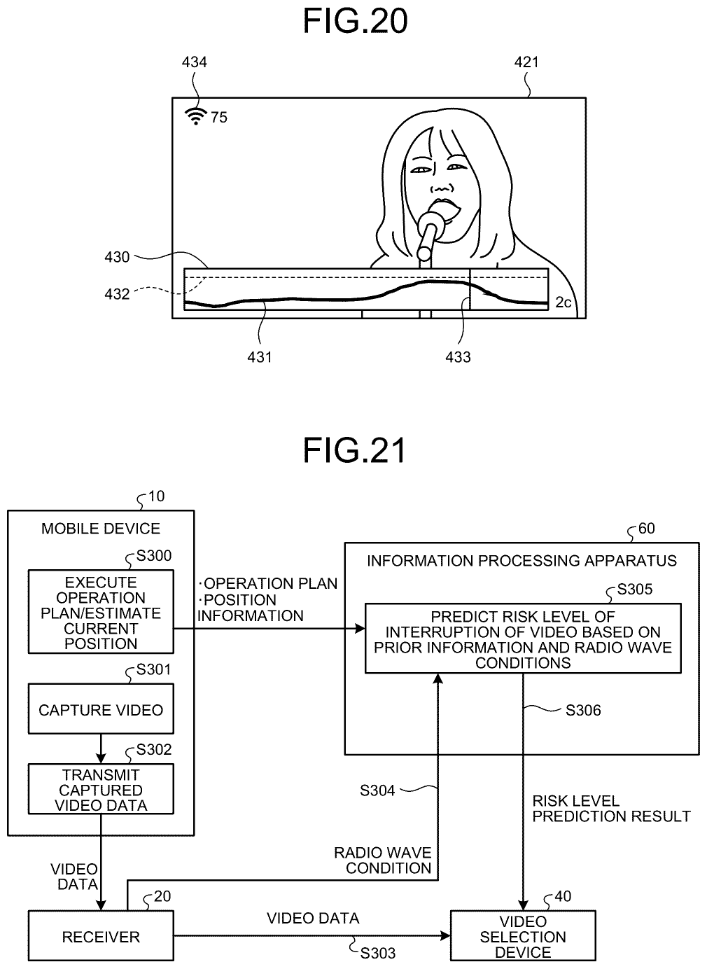

FIG. 20 is an enlarged schematic diagram illustrating the display area 421 according to the third embodiment. In FIG. 20, an indicator 434 arranged at the upper left of the display area 421 indicates the current signal strength of the video data transmitted from the mobile device 10 corresponding to the display area 421 (in this example, the mobile device 10 equipped with the camera 100 having the camera ID [2c]).

In the transition display 430 arranged in the lower part of the display area 421, the vertical axis indicates the signal strength, and the horizontal axis indicates the passage of time toward the right. In addition, a bar 433 indicates the current time, and a level indication line 432 indicates an allowable level for the signal strength. A characteristic line 431 indicates the transition of the signal strength of the video data transmitted from the mobile device 10 corresponding to the display area 421. In the characteristic line 431, the right side of the bar 433 indicating the current time shows a predicted value obtained by predicting the signal strength. This prediction value can be obtained on the basis of, for example, an operation plan for the mobile device 10 and a radio wave condition (radio wave condition map).

By checking the transition display 430, the user can determine whether or not there is a possibility that the video displayed in the corresponding display area 421 is interrupted. For example, in a case where there is a portion exceeding the level indication line 432 in the characteristic line 431 on the right side of the bar 433, it can be determined that there is a possibility that the video displayed in the display area 421 is interrupted in the near future (for example, after several seconds).

As an example, in a case where the user determines that there is a possibility that the video displayed in the display area 421 is interrupted on the basis of the transition display 430 in the display area 421 designated as the video to be output, the user can determine that the risk level of occurrence of an accident in which the video being distributed is interrupted is high. In this case, the user can switch the video to be output to a video by a camera 100 having another camera ID. As a result, it is possible to prevent an accident in which the video being distributed is interrupted.

The present invention is not limited thereto, and for example, the information processing apparatus 60 instructs the video selection device 40 to perform processing of switching an output video to a video by the camera 100 having another camera ID, whereby the video selection device 40 can be caused to automatically perform the switching processing.

FIG. 21 is a schematic diagram for explaining processing of obtaining a risk level of interruption of a video in distribution according to the third embodiment.

The mobile device 10 executes the operation plan passed in advance by the operation plan creation unit 602 and estimates the current position (step S300). The mobile device 10 transmits the operation plan and the position information indicating the estimated current position. The operation plan and the position information transmitted from the mobile device 10 are received by the information processing apparatus 60. The mobile device 10 moves and captures a video according to the operation plan (step S301), and transmits the captured video data (step S302).

In the video selection device 40, it is assumed that the video based on the video data transmitted in step S302 is selected as the video to be output.

The video data transmitted from the mobile device 10 is received by the receiver 20. The receiver 20 transfers the received video data to the video selection device 40 (step S303). Furthermore, the receiver 20 passes the signal strength information based on the video data transmitted from the mobile device 10 to the information processing apparatus 60 as a radio wave condition in an environment including the mobile device 10 and the receiver 20 (step S304).

The information processing apparatus 60 predicts the risk level of interruption of the video based on the video data transmitted from the mobile device 10 on the basis of the prior information (for example, the position of the receiver 20, the arrangement of the performer 51 and the equipment and the like 52) and the radio wave conditions passed from the receiver 20 (step S305).

For example, the information processing apparatus 60 predicts the probability that the video is interrupted in a case where the mobile device 10 moves after the current point of time on the basis of the operation plan of the mobile device 10, the position information indicating the position of the mobile device 10, and the radio wave condition map based on the radio wave condition. As an example, in a case where the mobile device 10 moves to an area with low radio field intensity on the basis of the operation plan, the position information, and the radio wave condition map, it is predicted that the probability that the video will be interrupted is high according to the radio field intensity of the destination. The information processing apparatus 60 transfers a value indicating this probability to the video selection device 40 as a prediction result of the risk level.

The video selection device 40 can automatically switch the video being output to the video captured by the different camera 100 according to the prediction result of the risk level transferred from the information processing apparatus 60. Furthermore, the video selection device 40 may display that there is a risk that the video being output is interrupted, and prompt the user to switch the video.

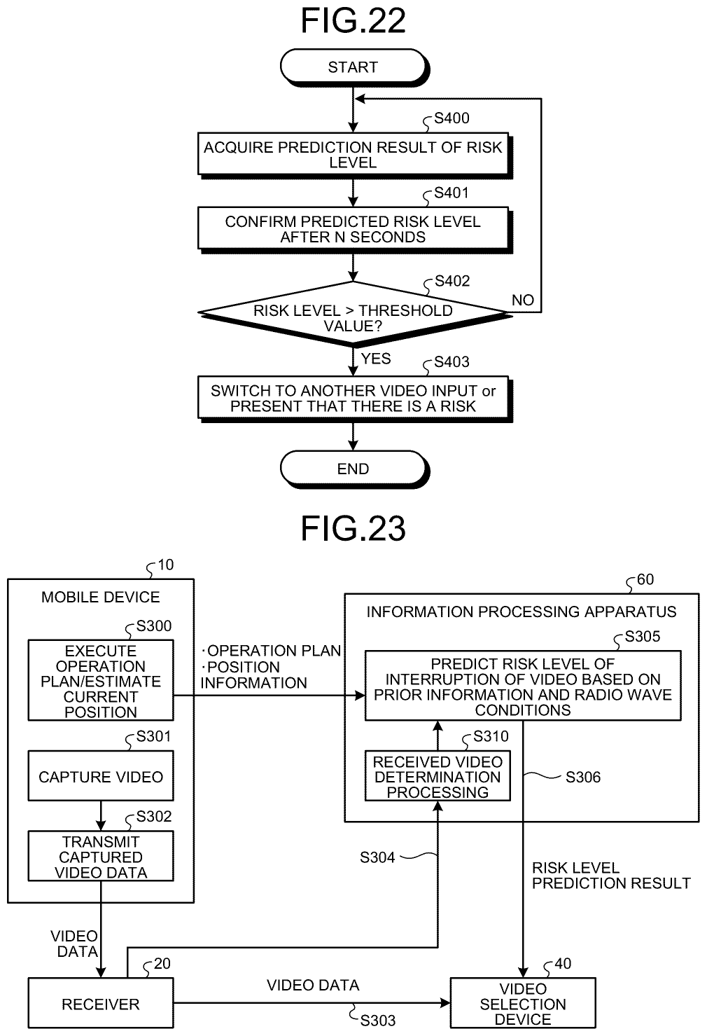

FIG. 22 is a flowchart of an example illustrating video switching processing according to a risk level in the video selection device 40 according to the third embodiment.

In step S400, the video selection device 40 acquires, from the information processing apparatus 60, a prediction result that predicts the risk level for the video being output. In the next step S401, the video selection device 40 confirms the predicted risk level after N seconds (N is a positive value) on the basis of the prediction result acquired in step S400. Note that N seconds may be a value set in advance in the video selection device 40, or may be a value set by the user.

In the next step S402, the video selection device 40 determines whether or not the risk level checked in step S401 exceeds a threshold value. When determining that the risk level is equal to or less than the preset threshold (step S402, “No”), the video selection device 40 returns the processing to step S400. On the other hand, when determining that the risk level exceeds the threshold (step S402, “Yes”), the video selection device 40 shifts the processing to step S403.

In step S403, the video selection device 40 switches the video being output to a video corresponding to another video input. More specifically, the video selection device 40 switches the mobile device 10 that transmits the video to be used for output from the current mobile device 10 to another mobile device 10. Alternatively, the video selection device 40 presents to the user that there is a risk that the video being output is interrupted.

Note that, in a case where the video selection device 40 switches the video being output to a video corresponding to another video input, a method of selecting a video after being switched can be variously considered. For example, it is conceivable that the most used video is registered in advance as the video for switching (displayed in advance in the display area 412 where the output candidate video is displayed), and the video being output is switched to the registered video. The video to be registered for switching is not limited to the most used video. For example, it is conceivable that the stage 50 is imaged at a long shot angle, and a highly versatile video such as a video in which the entire stage 50 is captured is registered as the video for switching.

Furthermore, for example, it is also conceivable that the video after being switched is a video based on video data transmitted in a good radio wave condition. Furthermore, for example, it is also conceivable that the video after being switched is a video captured with a composition similar to that of the video being output. Whether or not the compositions are similar to each other can be determined on the basis of the position and orientation of the mobile device 10 that is capturing a video.

As described above, according to the third embodiment, the video selection device 40 switches the video to be output according to the risk level for the video being output obtained by the information processing apparatus 60. Alternatively, the video selection device 40 prompts the user to switch the video to be output according to the risk level. Therefore, it is possible to prevent an accident such as interruption or disturbance of the video being distributed.

### 5-1. Modification of Third Embodiment

Next, a modification of the third embodiment will be described. In the third embodiment described above, the risk level for the video being output is obtained on the basis of the radio wave condition. On the other hand, in the modification of the third embodiment, the risk level is obtained on the basis of the video being output.

FIG. 23 is a schematic diagram for explaining processing of obtaining a risk level of interruption of a video in distribution according to the modification of the third embodiment. In FIG. 23, the received video determination processing in step S310 is added to the configuration in FIG. 21. In FIG. 21, the information processing apparatus 60 determines the presence or absence of disturbance of the video based on the received video data on the basis of the radio wave conditions passed from the receiver 20 (step S310).

For example, the information processing apparatus 60 predicts the presence or absence of disturbance of the video on the basis of the signal strength information included in the radio wave condition. For example, the information processing apparatus 60 can quantify the signal strength indicated by the signal strength information and predict that the disturbance occurs in the video in a case where the value indicating the signal strength is smaller than a predetermined value. The present invention is not limited thereto, and the information processing apparatus 60 may directly detect the presence or absence of disturbance from the video based on the video data. For example, the information processing apparatus 60 can detect the presence or absence of disturbance of the video on the basis of the continuity of the video. In this case, the presence or absence of the disturbance of the video can also be detected by video selection device 40.

For example, in a case where a device different from a normal device is used as the receiver 20 at the shooting site, for example, determination based on a video may be necessary. As an example, there may be a case where the receiver 20 does not have a function of measuring the strength of a signal. The modification of the third embodiment is suitable for such a case.

In addition, when disturbance of the video is detected during distribution of the video based on the video data captured by the mobile device 10, it is possible to acquire and record the position (coordinates) where the disturbance is detected and reflect the position in the radio wave condition map 800.

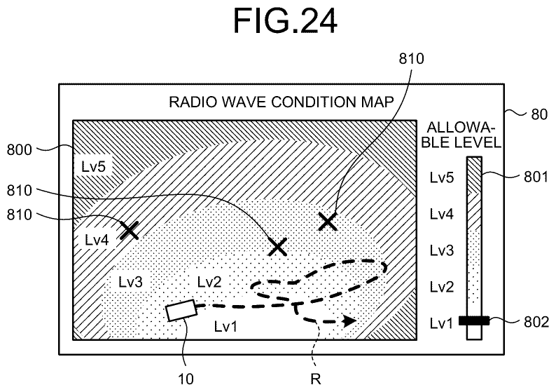

FIG. 24 is a schematic diagram illustrating an example in which a position where disturbance of a video is detected is reflected on the radio wave condition map 800 according to the modification of the third embodiment. In FIG. 24, the position where the disturbance of the video is detected is indicated by a mark 810 in the radio wave condition map 800. The user can set the route of the mobile device 10 by referring to each mark 810 of the radio wave condition map 800. Since the information indicated by the mark 810 is information closer to raw information at the shooting site, it can be expected to be an effective hint for the route of the mobile device 10.

Furthermore, the effects described in the present specification are merely examples and are not limited, and other effects may be provided.

Note that the present technology can also have the following configurations.

(1) An information processing system
comprising:
an acquisition unit that acquires a radio wave condition in an environment; and
a creation unit that creates an operation plan on the basis of the radio wave condition and radio field intensity necessary for transmitting video data to be used for distribution.

(2) The information processing system according to the above (1), further comprising:
a mobile device including a capturing video function, a transmitting function for transmitting video data captured by the capturing video function, and a movement mechanism for rotating and moving a housing,
wherein the acquisition unit
acquires the radio wave condition in the environment in which the mobile device operates, and
the creation unit
creates the operation plan indicating a plan of an operation of the mobile device on the basis of the radio wave condition and the radio field intensity necessary for transmitting video data used for distribution by the mobile device.

(3) The information processing system according to the above (2), wherein
the mobile device includes a first mobile device and a second mobile device, and
the creation unit
creates the operation plan for taking over an operation from the first mobile device to the second mobile device on the basis of the radio wave condition and the radio field intensity.

(4) The information processing system according to the above (3), wherein
the creation unit
creates the operation plan based further on a risk on movement of the first mobile device.

(5) The information processing system according to any one of the above (2) to (4),
further comprising:
a map generation unit that generates a map visualizing the radio wave condition; and
a display unit that displays the map.

(6) The information processing system according to the above (5), wherein
the creation unit
creates the operation plan based further on an allowable level for the radio field intensity in the radio wave condition set for the map.

(7) The information processing system according to the above (6), wherein
the creation unit
creates the operation plan on the basis of the allowable level set according to a user operation based on the map displayed on the display unit.

(8) The information processing system according to the above (7), wherein
the map generation unit
updates the map on the basis of the allowable level set according to the user operation.

(9)) The information processing system according to any one of the above (2) to (8),
further comprising:
a video display unit that receives the video data transmitted from the mobile device and displays a video based on the received video data; and
a video selection unit that selects a video to be used for distribution from the videos displayed on the video display unit,
wherein the creation unit
predicts a transition of the radio wave condition for the mobile device on the basis of the radio wave condition and the operation plan, and causes the video display unit to display information indicating the predicted transition of the radio wave condition.

(10) The information processing system according to the above (9), wherein
the creation unit
selects video data to be used for distribution from the video data transmitted from each of the mobile devices on the basis of the information indicating the transition of the radio wave conditions predicted for each of the mobile devices.

(11) The information processing system according to the above (10),
further comprising:
a determination unit that determines presence or absence of disturbance in a video based on the video data transmitted from the mobile device,
wherein the determination unit selects video data to be used for the distribution based further on the presence or absence of the disturbance.

(12) The information processing system according to the above (11),
further comprising:
a map generation unit that generates a map visualizing the radio wave condition; and
a display unit that displays the map,
wherein the creation unit
acquires position of the mobile device when the video data determined to have the disturbance is transmitted, and displays information indicating the acquired positions on the map.

(13) The information processing system according to any one of the above (2) to (12), wherein
the mobile device
includes an antenna for transmitting the video data by the transmission function in a part of a periphery of a housing of the mobile device, and
the creation unit
creates the operation plan including information for controlling the orientation of the mobile device on the basis of the position of the antenna.

(14) An information processing apparatus
comprising:
an acquisition unit that acquires a radio wave condition in an environment; and
a creation unit that creates an operation plan on the basis of the radio wave condition and radio field intensity necessary for transmitting video data.

(15) An information processing method
executed by a processor,
comprising steps of:
acquiring a radio wave condition in an environment; and
creating an operation plan on the basis of the radio wave condition and radio field intensity necessary for transmitting video data.

(16) An information processing program causing a computer to execute steps of:
acquiring a radio wave condition in an environment; and
creating an operation plan on the basis of the radio wave condition and radio field intensity necessary for transmitting video data.

### REFERENCE SIGNS LIST

1 Information Processing System
10, 10′, 10a, 10b, 10c, 10d, 10d, 10drn Mobile Device
20, 103 Receiver
21, 23, 101, 101t, 101ta, 101tb, 101tc, 101r Antenna
22, 102 Transmitter
40 Video Selection Device
50 Stage
51 Performer
52 Equipment and the Like
60 Information Processing Apparatus
70, 71, 80 Visualization Screen
100 Camera
104 Movement Mechanism
105 Housing
110 Imaging Unit
111 Sensor Information Acquisition Unit
112 Communication Unit
113 Drive Control Unit
200 Danger Area
403 Video Selection Screen
411, 412, 421 Display Area
430 Transition Display
434 Indicator
601 Radio Wave Condition Acquisition Unit
602 Operation Plan Creation Unit
603 Map Generation Unit
604 Display Unit
605 Input Unit
606 Communication Unit
800 Radio Wave Condition Map
801 Slider
802 Knob
810 Mark

1. An information processing system comprising:
an acquisition unit that acquires a radio wave condition in an environment; and
a creation unit that creates an operation plan on the basis of the radio wave condition and radio field intensity necessary for transmitting video data to be used for distribution.

2. The information processing system according to claim 1, further comprising:
a mobile device including a capturing video function, a transmitting function for transmitting video data captured by the capturing video function, and a movement mechanism for rotating and moving a housing,
wherein the acquisition unit
acquires the radio wave condition in the environment in which the mobile device operates, and
the creation unit
creates the operation plan indicating a plan of an operation of the mobile device on the basis of the radio wave condition and the radio field intensity necessary for transmitting video data used for distribution by the mobile device.

3. The information processing system according to claim 2, wherein
the mobile device includes a first mobile device and a second mobile device, and
the creation unit
creates the operation plan for taking over an operation from the first mobile device to the second mobile device on the basis of the radio wave condition and the radio field intensity.

4. The information processing system according to claim 3, wherein
the creation unit
creates the operation plan based further on a risk on movement of the first mobile device.

5. The information processing system according to claim 2,
further comprising:
a map generation unit that generates a map visualizing the radio wave condition; and
a display unit that displays the map.

6. The information processing system according to claim 5, wherein
the creation unit
creates the operation plan based further on an allowable level for the radio field intensity in the radio wave condition set for the map.

7. The information processing system according to claim 6, wherein
the creation unit
creates the operation plan on the basis of the allowable level set according to a user operation based on the map displayed on the display unit.

8. The information processing system according to claim 7, wherein
the map generation unit
updates the map on the basis of the allowable level set according to the user operation.

9. The information processing system according to claim 2,
further comprising:
a video display unit that receives the video data transmitted from the mobile device and displays a video based on the received video data; and
a video selection unit that selects a video to be used for distribution from the videos displayed on the video display unit,
wherein the creation unit
predicts a transition of the radio wave condition for the mobile device on the basis of the radio wave condition and the operation plan, and causes the video display unit to display information indicating the predicted transition of the radio wave condition.

10. The information processing system according to claim 9, wherein
the creation unit
selects video data to be used for distribution from the video data transmitted from each of the mobile devices on the basis of the information indicating the transition of the radio wave conditions predicted for each of the mobile devices.

11. The information processing system according to claim 10,
further comprising:
a determination unit that determines presence or absence of disturbance in a video based on the video data transmitted from the mobile device,
wherein the determination unit selects video data to be used for the distribution based further on the presence or absence of the disturbance.

12. The information processing system according to claim 11,
further comprising:
a map generation unit that generates a map visualizing the radio wave condition; and
a display unit that displays the map,
wherein the creation unit
acquires position of the mobile device when the video data determined to have the disturbance is transmitted, and displays information indicating the acquired positions on the map.

13. The information processing system according to claim 2, wherein
the mobile device
includes an antenna for transmitting the video data by the transmission function in a part of a periphery of a housing of the mobile device, and
the creation unit
creates the operation plan including information for controlling the orientation of the mobile device on the basis of the position of the antenna.

14. An information processing apparatus comprising:
an acquisition unit that acquires a radio wave condition in an environment; and
a creation unit that creates an operation plan on the basis of the radio wave condition and radio field intensity necessary for transmitting video data.

15. An information processing method
executed by a processor,
comprising steps of:
acquiring a radio wave condition in an environment; and
creating an operation plan on the basis of the radio wave condition and radio field intensity necessary for transmitting video data.

16. An information processing program causing a computer to execute steps of:
acquiring a radio wave condition in an environment; and
creating an operation plan on the basis of the radio wave condition and radio field intensity necessary for transmitting video data.
